(19) United States
(12) Patent Application Publication
(10) Pub. No.: US 2016/0086091 A1
(43) Pub. Date: Mar. 24, 2016

(54) SYSTEM AND METHOD FOR TESTING FOR INDIVIDUAL PROPENSITY FOR BIAS IN DECISION MAKING ABILITY

(71) Applicant: Versive Ventures, LLC, La Jolla, CA (US)

(72) Inventor: Mark Ellis, La Jolla, CA (US)

(73) Assignee: Versive Ventures, LLC, La Jolla, CA (US)

(21) Appl. No.: 14/864,150

(22) Filed: Sep. 24, 2015

Related U.S. Application Data
(60) Provisional application No. 62/054,867, filed on Sep. 24, 2014.

(51) Int. Cl. G06N 5/04; G06F 3/0484

(52) U.S. Cl. CPC G06N 5/048; G06F 3/04842

(57) ABSTRACT

The subject matter disclosed herein provides methods for testing decision-making ability by measuring a test subject's implicit disposition for bias. A series of sorting tasks can be generated for a user of a computer associated with a machine. At least two digital representations of association categories can be provided. A sequence of two or more trials can be executed. Each trial can provide a randomly-selected digital representation of a stimulus that can provide at least two digital representations of association categories; receive a selection by the user in response to the stimulus; and record a time between providing the randomly-selected digital representation of the stimulus and receiving the selection by the user. A score can be calculated reflecting the strength of the user's implicit association between one pair of relatedness and biasedness categories and a different pair. Related apparatus, systems, techniques, and articles are also described.

### CROSS-REFERENCE TO RELATED APPLICATIONS

This application claims priority to and the benefit of U.S. Provisional Patent Application No. 62/054,867, titled, “System and Method for Testing for Individual Propensity for Bias IN Decision Making Ability”, filed Sep. 24, 2014, the disclosure of which is incorporated herein by reference in its entirety.

### TECHNICAL FIELD

The subject matter described herein relates to computer-implemented testing, and more particularly to a computer-implemented system and method for testing decision-making ability by measuring a test subject's implicit disposition for bias.

### BACKGROUND

The discovery of the prevalence of cognitive bias is considered one of the crowning achievements of modern psychological science. Much has been written about various ways bias permeates human decision-making processes and directs human reasoning, and its deleterious, and even sometimes disastrous, consequences.

While bias is prevalent, it is not manifested equally by all people. Like any other cognitive capacity, the predisposition for biased thinking varies from person to person. This raises the question of whether individuals with strong bias-resistance can be identified as part of the selection process for roles where such resistance would be highly valued. To do so would require (1) identifying a character trait or disposition that underlies biased thinking; and (2) a mechanism to test for this character trait with high validity, i.e., one that can predict behavior outside the test environment.

Two major classes of motives have been shown to bias reasoning. Social motives reflect the desire to manage the impression made by one's actions on others and to interact smoothly with other people. This “us” bias appears as a desire for harmony and agreement with friends and allies, as well as in-group favoritism and apologism (“He may be a crook, but he's our crook”). Coherence motives reflect the desire to preserve one's positive self-concept as intelligent, rational and objective. Threats to one's worldview and sense of self trigger defensive mechanisms (the “me” bias), such as overconfidence; confirmatory search, interpretation and recall of evidence (“confirmation bias”); and motivated reasoning. In short, cognitive bias is the result of “self-serving information processing” that favors one's own or his/her group's beliefs, preferences, interests, and attitudes over others'.

One of the signature manifestations of self-serving information processing is “bias blindness”, or the tendency to believe that others are biased but that we and, by extension, the groups to which we belong, are not. Bias blindness has been referred to as a “meta-bias” because it is a “bias about bias”, but also, and more importantly, it inherently blinds one from one's errors in judgment, thereby providing a foundation for all other cognitive biases. Bias blindness can therefore serve as a proxy for a generalized propensity for biased thinking.

Psychological testing of individual personality traits and cognitive abilities is frequently used in a variety of contexts: employment; legal and criminal; medical; government; military; intelligence. A number of these tests attempt to measure a subject's decision-making ability, typically following one of three formats: maximal performance, self-report, or observational. All three of these formats share the weakness that when subjects know they are being tested or observed, they respond differently than under typical (“real-world”) conditions, usually in the manner they believe is desired by the person or organization administering the test. This is particularly true for assessments of socially sensitive or undesirable personality or cognitive attributes, such as bias. Consequently, existing tests of decision-making ability have low validity in predicting behavior outside the test environment.

Tests for decision-making ability typically attempt to measure “critical thinking”, which may assess some manifestations of cognitive bias (e.g., ignorance of basic probability, inconsistent risk preferences). Because these tests are taken under optimal (i.e., test) conditions, they are not valid predictors of performance outside the test environment. Tests specifically targeting cognitive bias have been developed for research purposes, but they suffer from subjects' ability to train for them, as they often entail mathematical problems whose solutions are not intuitive but can be solved using basic arithmetic. For highly intelligent subjects in particular, these tests are not expected to be valid predictors of performance outside the test environment. Research has shown that IQ does not mitigate the propensity for bias, and that IQ and bias may instead be inversely correlated.

One type of psychological assessment that tests for bias is known as the Implicit Association Test (IAT). The IAT provides a measure of a user's relative strengths of association between two sets of concepts, generally a target (e.g., male, female) and an evaluative attribute (e.g., career, family). To determine the relative strengths of association between the two sets of concepts, the user is asked in a series of trials to sort stimuli representative of each of the two targets and each of the two attributes, using a single response for the first target-attribute pair and a different response for the second target-attribute pair. The response times for this first sorting exercise are recorded. A second block of sorting trials switches either the two target categories or the two attribute categories, such that one response is associated with the first target and second attribute (or second target and first attribute) categories, and the other response is associated with the second target and first attribute (or first target and second attribute) categories. The “IAT effect” (or score) is a function of the difference in the average response times for each of the two blocks of trials. The IAT has been shown to be highly resistant to preparation and socially desirable responding, or “faking” one's response, and the IAT effect has demonstrated high validity in predicting behavior outside the test environment.

A test of an individual's propensity for motivated cognition and self-serving information processing would be highly valuable in any setting in which his or her financial, emotional, social, or psychological motives, whether conscious or unconscious, might bias their decision-making ability. To be effective, this instrument would also need to have high validity in predicting behavior outside the test environment, and be resistant to preparation and socially desirable responding. The proposed “Bias-Blindness Implicit Association Test” (BB-IAT), an adaptation of the IAT methodology that overcomes the above-described weaknesses of existing psychological assessments, is the first psychological test to assess an individual's generalized disposition for motivated cognition with high predictive validity and resistance to preparation and socially desired responding.

### SUMMARY

As used henceforth, the term “relatedness” is relative to the user, i.e., self, in-group, or other, while the term “biasedness” refers to the quality of being biased or unbiased. In one aspect, a computer-implemented method and a computer system to execute a method are provided. The method includes generating, by one or more processors of a machine, a series of sorting tasks for a user of a computer associated with the machine, the computer including an output device and an input device, each of the series of sorting tasks comprising a plurality of digital representations of stimuli associated with either relatedness to the user or biasedness. The method further includes providing, by the one or more processors, at least two digital representations of association categories as separate outputs from the output device, at least one of the at least two digital representations of the association categories being associated with the user's relatedness, and at least one other of the at least two digital representations of the association categories being associated with the user's biasedness, each of the separate outputs being associated with an input actuator of the input device.

The method further includes executing, by the one or more processors, a sequence of two or more trials. Each trial includes providing, by the one or more processors, a randomly-selected digital representation of a stimulus to the output device in proximity to the separate outputs that provide the at least two digital representations of the association categories, the stimulus being associated with either the user's relatedness or biasedness represented by the at least two digital representations of the association categories. The execution of each trial further includes receiving, by the one or more processors, a selection by the user from the input actuator of the input device in response to the stimulus, the selection indicating a category with which the user associates the stimulus, and recording, by the one or more computer processors, a time between providing the randomly-selected digital representation of the stimulus and receiving the selection by the user via the input device.

The method further includes calculating, by the one or more computer processors, a score of the user's relative strength of association of at least two association categories of the user's relatedness or biasedness with at least one association category of the other of the user's relatedness or biasedness, the score being based at least partially on the time between providing the at least two randomly-selected digital representations of stimuli and receiving the selection by the user via the input device for each of the trials in the sequence of two or more trials.

Implementations of the current subject matter can include, but are not limited to, systems and methods consistent with the disclosure herein, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a communications network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram of a system that executes a method as described herein;

FIG. 2 illustrates a Bias-Blindness IAT combined task screen layout;

FIG. 3 summarizes a Bias-Blindness IAT block and trial structure;

FIG. 4 illustrates a Bias-Blindness Brief IAT combined task screen layout;

FIG. 5 summarizes a Bias-Blindness Brief IAT block and trial structure;

FIG. 6 illustrates a Bias-Blindness Single-Target IAT screen layout;

FIG. 7 illustrates a Bias-Blindness Single-Attribute IAT screen layout;

FIG. 8 summarizes a Bias-Blindness Single-Target IAT block and trial structure;

FIG. 9 summarizes a Bias-Blindness Single-Attribute IAT block and trial structure;

FIG. 10 illustrates a Bias-Blindness Recoding-Free IAT combined task screen layouts;

FIG. 11 summarizes a Bias-Blindness Recoding-Free IAT block and trial structure;

FIG. 12 illustrates a Bias-Blindness Single-Block IAT combined task screen layouts;

FIG. 13 summarizes a Bias-Blindness Single-Block IAT block and trial structure;

FIG. 14 summarizes the block response data used in the conventional and D score algorithms under various IAT implementations; and

FIG. 15 provides illustrative lists of stimuli in the various target and attribute categories that can be used with the Bias-Blindness IAT.

When practical, similar reference numbers denote similar structures, features, or elements.

### DETAILED DESCRIPTION

To address the issues with currently available solutions, one or more implementations of the current subject matter can, among other possible advantages, provide a system and method, article of manufacture, and the like, to accurately assess the strength of a person's disposition toward biased thinking.

In response to the shortcomings of maximal performance, self-report, and observational measures described above, the IAT has been developed to assess an individual's implicit beliefs and attitudes—those he or she may not be consciously aware of or, if he or she is, would not admit to, yet nonetheless strongly influence his or her behavior. The systems and methods described herein use the IAT in a new “bias blindness” configuration to measure the strength of an individual's tendency to engage in biased thinking.

While self-reports measuring bias blindness are unlikely to yield accurate results (due to social-desirability bias), a suitably-constructed IAT can be used to measure implicit attitudes. This can be done by modifying the IAT to measure the relative strengths of associations (i.e., speed of response) between target categories representing “Self” and “Other” and attribute categories representing “Unbiased” (e.g., “impartial”, “rational”, dispassionate”) and “Biased”. The expectation is that the tendency toward self-serving information processing will manifest itself in faster response times when the same response is required for “Self” and “Unbiased” stimuli, or “Other” and “Biased” stimuli (the “compatible” associations), than when the same response is required for the “incompatible” “Self” and “Biased”, or “Other” and “Unbiased”, stimuli. By timing the user's response latencies, a system and method can test and measure the user's relative strengths of associations between self or others and the qualities of being biased or unbiased.

The system and method are designed to detect the strength of a person's automatic associations between different concepts. As executed, a method requires subjects to rapidly categorize two target concepts with an attribute (e.g., the concepts “male” and “female” with the attribute “logical”), such that easier pairings (faster responses) are interpreted as more strongly associated in memory than more difficult pairings (slower responses). Because the system requires that subjects make a series of rapid judgments, the scores reflect attitudes that people are unwilling to reveal publicly. Accordingly, the system and method are configured to get around a social-desirability bias, and to assess subjects' implicit attitudes.

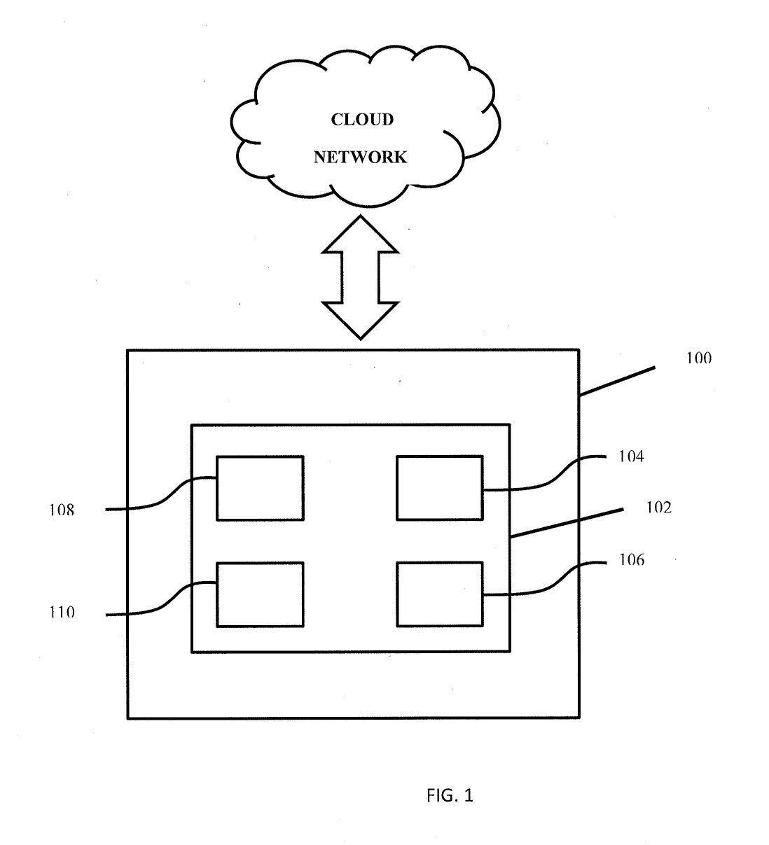

In accordance with preferred implementations, and as shown in FIG. 1, the method is executed and administered electronically on a system 100, which includes a computer 102. The computer 102 can be any terminal (i.e., where processing is done in a different device, such as a remote server), mobile device (smartphone or tablet), purpose-built device, or other computing device.

The computer 102 includes a display 104 to present the test-subject the stimuli to elicit a response, and provide instructions and other information and feedback needed to administer the test. The computer 102 further includes a processor 106 to execute the test, to register and time the subject's responses, to generate any other information needed by the subject to complete the test (e.g., instructions, feedback), and to process the subject's responses and calculate a score. The computer 102 further includes an electronic storage medium 108, which is embodied as a non-transient electronic storage medium (e.g., chip-, disk-, or tape-based) to record and store the subject's responses for later processing by the processor. The computer 102 also includes an electronic input mechanism 110 having at least two inputs for registering at least two different responses (e.g., left and right) and relaying the inputs to the processor 106. The electronic input mechanism 110 can be a keyboard, a keypad, a touchscreen, a switch, a mouse, a trackball, one or more paddles, push-buttons, and/or the like.

The system 100 includes program instructions that are stored on the electronic storage medium 108 and executable by the processor 106, to direct the display 104, processor 106, electronic storage medium 108, and electronic input device 110 to administer the test by presenting a subject with instructions, stimuli, and feedback on the display 104, and accepting input from the electronic input mechanism 110 for recording and storage in the electronic storage medium 108, as described in more detail below.

In accordance with some implementations, a method for testing for individual propensity for bias in decision-making ability includes a series of tasks, organized into blocks of multiple trials. According to one exemplary implementation, execution of a “Bias-Blindness IAT” begins with the presentation of instructions to the user. These instructions explain how the category headings and stimuli will be presented to the user, how the user inputs his or her responses, and how to respond when an error message is received following an incorrect input (the test does not proceed until the other, correct, response is entered). The instructions also list all the categories that will be used in the test and, if words are used, lists the stimuli in each category (if other stimuli, e.g., images, are used, they are described). Execution then proceeds through a series of seven tasks, generally as follows.

The first task is “target concept practice”. The test-taker is asked to categorize target concept stimuli into “Self” and “Other” categories. On the display 104, the word “Self” (or a related word) appears in the upper left of the display 104 as a category heading, while the word “Other” (or a related word) appears in the upper right of the display 104. In the center of the display 104 appears a randomized sample from either a group of stimuli (usually words, but potentially images, sounds or other computer-renderable stimuli) typically associated with either the concept of “Self” (e.g., “I”, “Me”, “Mine”) or a group of stimuli typically associated with the concept of “Other” (e.g., “They”, “Them”, “Him”). The respondent sorts each stimulus that appears in the center of the display 104 into the appropriate category by activating an associated input of the electronic input mechanism 110. For instance, the electronic input mechanism 110 can be a keyboard or keypad, and the associated input can be a left-hand or right-hand key (e.g., “E” or “I” on a computer keyboard) to correspond with the left side and right side of the display 104. This process is repeated for several trials (typically twenty), and the time it takes the respondent to sort each stimulus is recorded by the system.

The second task is “attribute concept practice”. The test-taker completes a sorting procedure similar to the first task, with attribute concept stimuli related to freedom-from-bias and biasedness. “Unbiased” (or a related word) now appears as a category heading in the upper left of the display 104, and “Biased” (or a related word) appears as a category heading in the upper right. In the center of the display 104 appears a randomized sample from either a group of stimuli related to the concept of being “Unbiased” (e.g., “Impartial”, “Objective, “Fair”) or a group of stimuli related to the concept of being “Biased” (e.g., “Irrational”, “Unfair”, “Emotional”). The test-taker sorts each stimulus that appears in the center of the display 104 into the appropriate category by activating the associated input mechanism. This process is repeated for several trials (typically twenty), and the time it takes the respondent to sort each stimulus is recorded by the system.

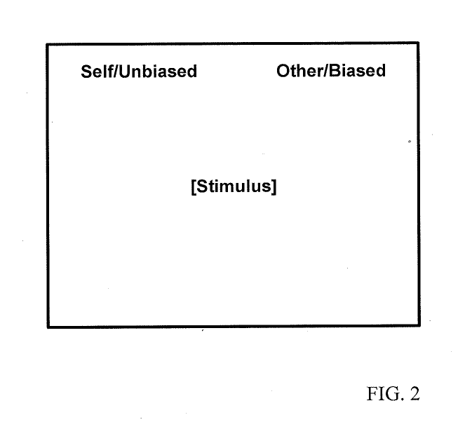

The third task, “first combined task practice”, combines both the target and attribute concepts from the first two tasks. “Self/Unbiased” (or related words) appear in the upper left of the display 104 as category headings, while “Other/Biased” (or related words) appear in the upper right as category headings. In the center of the display 104 appears a randomized sample from the four lists used in the first two tasks containing stimuli associated with or related to the concepts of “Self”, “Other”, “Unbiased” and “Biased”. The test-taker sorts each stimulus that appears in the center of the display 104 into the appropriate category by activating the associated input mechanism: for example, the left-hand key if the stimulus is associated with the “Self/Unbiased” categories, and the right-hand key if it is associated with the “Other/Biased” categories. This process is repeated for several trials (typically twenty), and the time it takes the respondent to sort each stimulus is recorded by the system. FIG. 2 illustrates the screen layout for the combined task.

The fourth task is the “first combined task test”. It repeats the third task, but with more trial repetitions (typically forty), and the time it takes the respondent to sort each stimulus is recorded by the system.

The fifth task is “target concept reversal practice”. It repeats the first task, but with the position of the two target concept category headings reversed: for instance, consistent with the example above, “Self” is now in the upper right and “Other” in the upper left of the display 104. The number of trials of the fifth task is typically doubled from the first task (e.g., to forty), and the time it takes the respondent to sort each word is recorded by the system.

The sixth task is the “second combined task practice”. It repeats the third task (including the number of trials), except that the target concept headings are reversed: “Other/Unbiased” is now in the upper left of the display 104, “Self/Biased” in the upper right. The time it takes the respondent to sort each word is recorded by the system.

The seventh task, the “second combined task test”, repeats the sixth task but with more trials (typically forty). The time it takes the respondent to sort each word is recorded by the system.

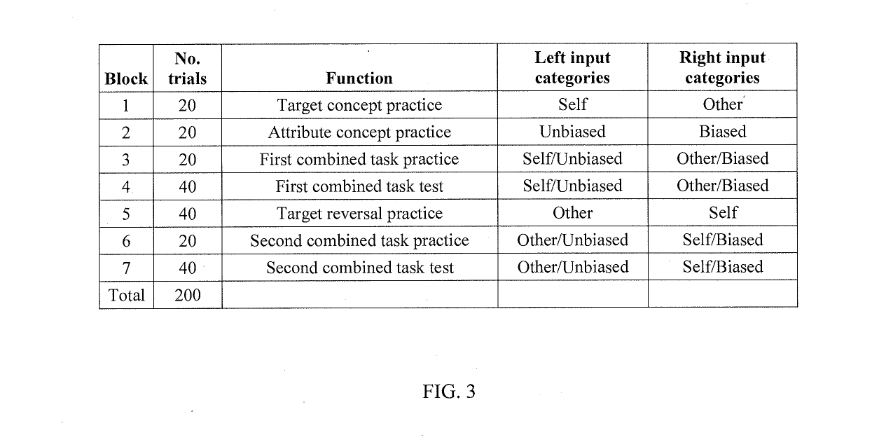

FIG. 3 is a table that summarizes the block and trial structure, and the target and attribute category headings for each block, of the Bias-Blindness IAT.

If the user implicitly associates each of the “Self” and “Other” target concepts with each of the “Unbiased” and “Biased” attribute concepts to differing degrees, the pairing reflecting the stronger association should be easier for the participant. For example, if participants consider themselves unbiased, they will be able to sort the stimuli into their associated categories more quickly when “Self” and “Unbiased” responses, and “Other” and “Biased” responses, are paired together than when “Self” and “Biased”, and “Other” and “Unbiased”, are paired.

A measure of the test subject's implicit bias, known as the “IAT effect”, is calculated from the response times recorded by the system. The IAT effect for the Bias-Blindness IAT indicates the strength of the test subject's associations of his or her self with unbiasedness and of others with biasedness, relative to the strength of the subject's associations of others with unbiasedness and of his or herself with biasedness. A basic scoring methodology, commonly referred to as the “conventional algorithm”, entails the following steps:
1. Use data only from the test blocks (4 and 7).
2. Drop the first two trials of each block.
3. Retain error-trial latencies in the analyzed data.
4. Recode latencies outside of a lower (300 milliseconds) and upper (3,000 milliseconds) boundaries to those boundary values.
5. Log-transform latencies.
6. Compute the average of the recoded, log-transformed latencies for blocks 4 and 7.
7. The IAT effect is equal to the difference in the two averages (block 4 minus block 7).

An improved scoring algorithm, demonstrated to have superior psychometric properties to a wide variety of alternative approaches, is known as the “D score”. This method differs from the conventional algorithm by using more of the recorded data and not log-transforming them, and in its treatment of trials with errors and large latencies. The D score algorithm consists of the following steps:
1. Use data from all four combined task blocks (3, 4, 6 and 7).
2. Remove trials with latencies greater than 10,000 milliseconds.
3. Compute the mean of all correct response times for each of the four blocks.
4. Compute one pooled standard deviation for all trials (correct and incorrect) in blocks 3 and 6, and another for blocks 4 and 7.
5. Replace each error latency with its block mean (computed in Step 3)+600 milliseconds.
6. Average the resulting values (including the recoded error latencies) for each of the four blocks.
7. Compute the two differences between blocks 6 and 3, and between blocks 7 and 4.
8. Divide each difference by its associated pooled-trials standard deviation from Step 4.
9. The IAT effect D score is equal to the average of the two quotients calculated in Step 8.

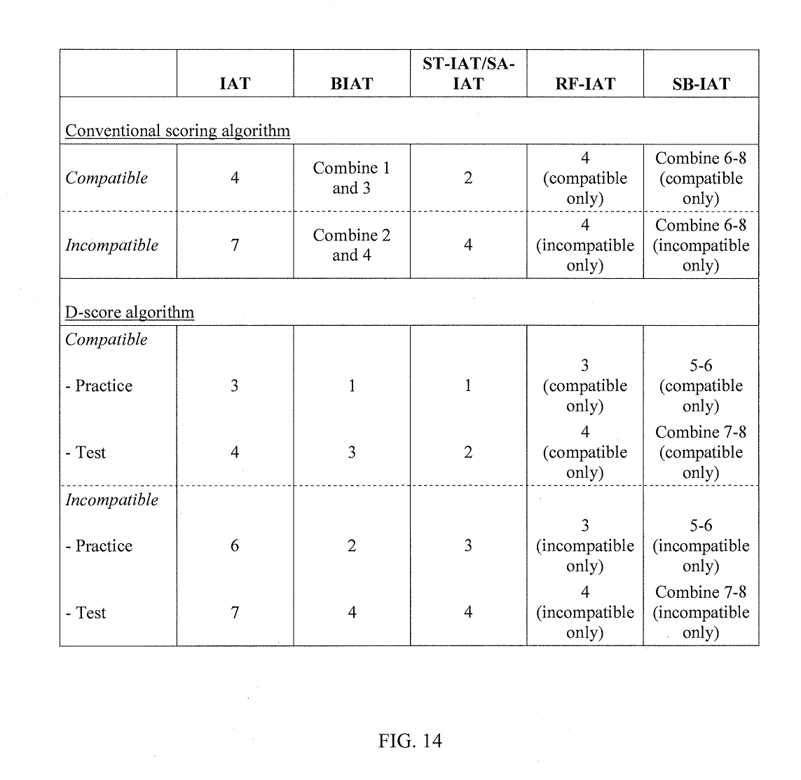

The table in FIG. 14 (at the end of this document) summarizes the block response data used in calculating the IAT effect under each scoring algorithm.

The D score algorithm generates a score ranging from −2 to +2. For the Bias-Blindness IAT, a score of +2 would indicate that the test subject has strong associations of his or her self with unbiasedness and of others with biasedness, relative to the subject's associations of others with unbiasedness and of his or herself with biasedness. Importantly, the score for the Bias-Blindness IAT, under both scoring algorithms, is interpreted inversely from the typical IAT scoring procedure: the stronger the respondent's relative association with unbiasedness (i.e., the higher their score), the stronger their “bias blindness” and actual susceptibility to bias.

A second implementation of the Bias-Blindness IAT uses a shorter version of the IAT known as the “Brief IAT” (BIAT). The BIAT takes less time to administer than the standard IAT, while retaining its predictive validity. The Brief IAT removes the target and attribute concept practice blocks to reduce the time needed to administer the test. In addition, it provides target or attribute concept category headings for only one of the potential responses (left- or right-sided); the heading for the other response is simply “Anything else” or a phrase of similar meaning.

The Bias-Blindness Brief IAT involves four tasks:

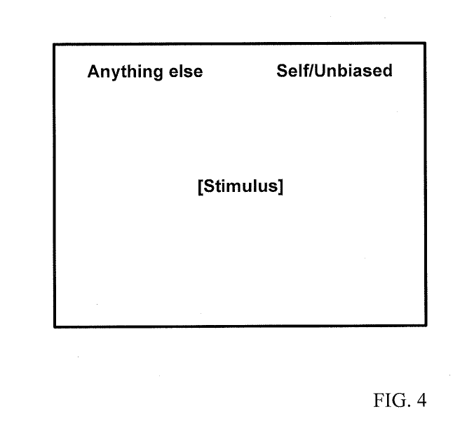

The first task is the “first combined task”. “Self/Unbiased” (or related words) appear in the upper right of the display 104, while “Anything else” (or related words) appears in the upper left. In the center of the display 104 appears a randomized sample from the four groups of stimuli associated with or related to the concepts of “Self”, “Other”, “Unbiased” and “Biased”. The test-taker sorts each stimulus that appears in the center of the display 104 into the appropriate category by activating the associated input mechanism: for example, the right-hand key if the stimulus is associated with either of the “Self/Unbiased” categories, and the left-hand key otherwise. This process is repeated for several trials (typically twenty to twenty-four), and the time it takes the respondent to sort each stimulus is recorded by the system. FIG. 4 illustrates the screen layout for the combined task.

The “second combined task” repeats the first task, but with “Self” replacing “Other” in the upper right category heading. The test-taker presses the right-hand key for each stimulus that is associated with the “Other/Unbiased” category, and the left-hand key otherwise.

The “third combined task” repeats the first task.

The “fourth combined task” repeats the second task.

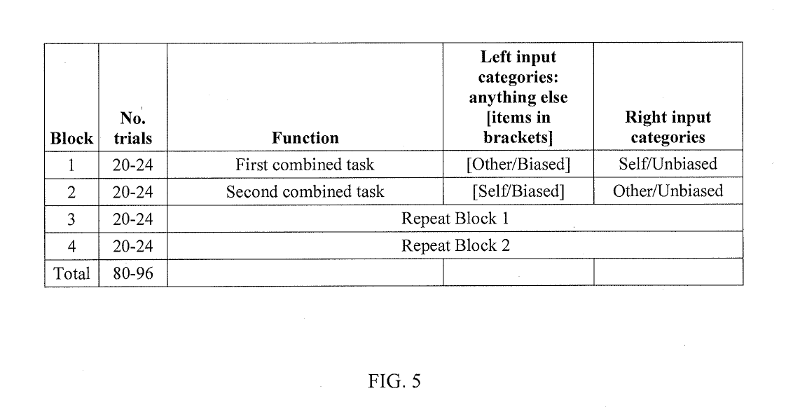

FIG. 5 summarizes the block and trial structure, and the target and attribute category headings for each block, of the Bias-Blindness Brief IAT.

Alternative implementations of the Bias-Blindness BIAT include reversing the inputs (i.e., right-sided response for “Anything else”), rearranging the ordering of the blocks, and/or substituting “Biased” (and the corresponding responses) in all category headings where “Unbiased” is used in the above description.

The IAT effect for the Bias-Blindness Brief IAT can be computed using either scoring algorithm described above, although the D score is preferred. Under the conventional algorithm, the data recorded in blocks 1 and 3 under the BIAT procedure are combined and substituted for block 4, and blocks 2 and 4 are combined and substituted for block 7. Using the D score algorithm, blocks 1, 3, 2 and 4 are substituted for blocks 3, 4, 6, and 7, respectively. The table in FIG. 14 (at the end of this document) summarizes the block response data used in calculating the IAT effect under each scoring algorithm for the Brief IAT.

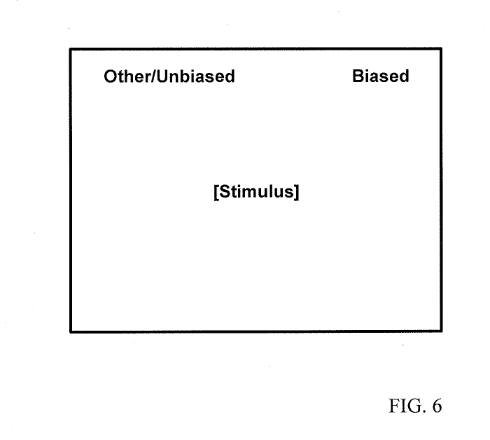

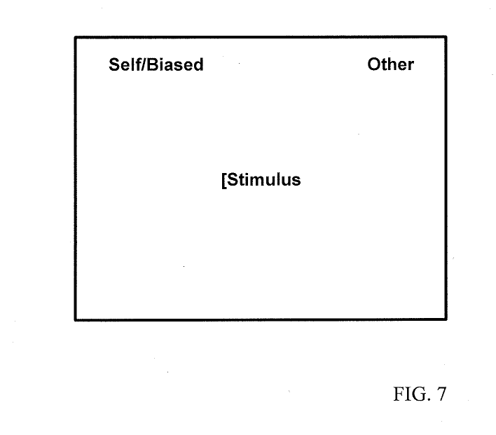

Third and fourth implementations of the Bias-Blindness IAT use only a single target or attribute concept, respectively. These implementations are useful when the target or attribute concept does not have an obvious polar opposite (e.g., ethnicity) or has associations beyond those the IAT is intended to measure (e.g., most positive-valence attributes in relation to the self). In these implementations, the category headings for the target or attribute concept in question are simply not presented, and their respective stimuli are replaced with another randomized sample from the remaining attribute or target concept. The diagrams in FIG. 6 and FIG. 7 below illustrate the screen layouts of the Bias-Blindness “Single-Target IAT” (ST-IAT) and “Single-Attribute IAT” (SA-IAT), respectively.

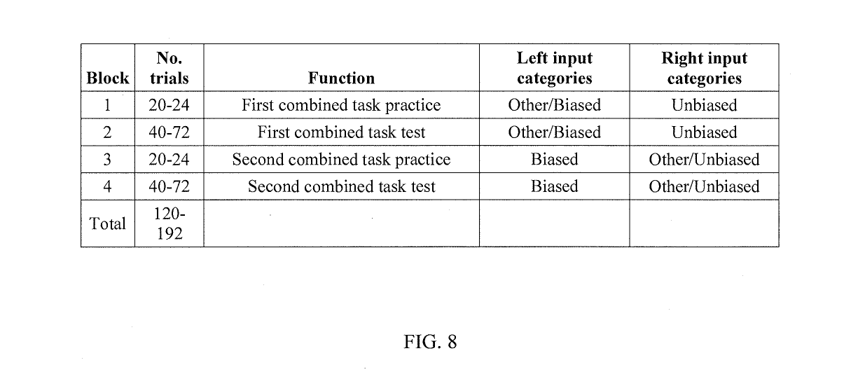

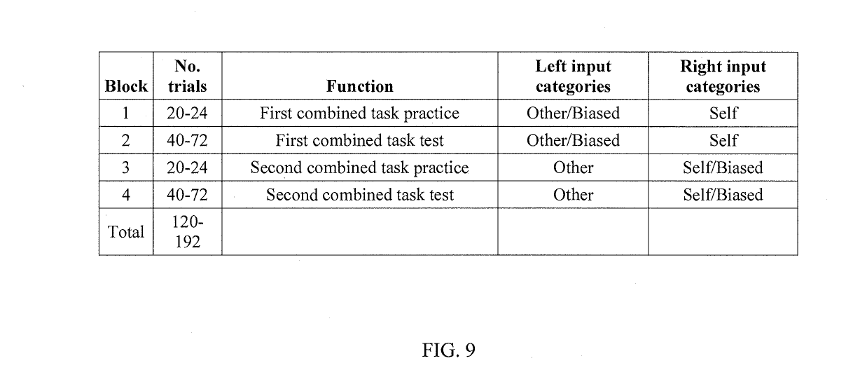

The ST-IAT and SA-IAT are typically implemented without the three target and attribute concept practice blocks included in the original IAT procedure, and the number of trials in the test blocks is frequently increased. The tables in FIG. 8 and FIG. 9 summarize the block and trial structure, and the target and attribute category headings for each block, of the Bias-Blindness Single-Target and Single-Attribute IATs, respectively.

The IAT effect for both the Single-Target and Single-Attribute IATs can be computed using either scoring algorithm described above, although the D score is preferred. Under the conventional algorithm, the data recorded in blocks 2 and 4 are substituted for blocks 4 and 7. Using the D score algorithm, blocks 1, 2, 3 and 4 are substituted for blocks 3, 4, 6, and 7, respectively. The table in FIG. 14 (at the end of this document) summarizes the block response data used in calculating the IAT effect under each scoring algorithm for both the ST-IAT and SA-IAT.

A fifth implementation of the Bias-Blindness IAT entails administering the third and fourth implementations in succession (#3 followed by #4, or vice versa) and averaging their scores or otherwise processing the collected response-time data into a combined metric, specifically to mitigate the influence of most people's positive self-concept.

Two other implementations of the IAT randomly require the user to provide a different response in sorting stimuli to categories, to prevent what is known as “recoding”. Recoding refers to sorting the presented stimuli not in terms of the nominal definitions of their respective target and/or attribute categories, but instead on the basis of some other feature that discriminates between both the two target categories and the two attribute categories. This typically helps to simplify one of the two combined tasks of an IAT, thereby skewing the results.

A sixth implementation of the IAT, known as the “Recoding-Free IAT” (IAT-RF), randomly shuffles the category headings to reduce recoding. It consists of four tasks:

The first task is “attribute concept practice”. “Biased” and “Unbiased” appear in the upper left and upper right of the display 104, respectively, as category headings. In the center of the display 104 appears a stimulus randomly selected from either of the two groups of stimuli associated with or related to each of these two concepts. The respondent sorts each stimulus into the appropriate category by activating the associated input of the electronic input mechanism 110. This process is repeated for several trials (typically sixteen), and the time it takes the respondent to sort each stimulus is recorded by the system.

In the second task, “target concept practice”, the test-taker completes a sorting procedure similar to the first task. For each trial, one of the target concepts “Self” or “Other” is randomly selected to appear in the upper left corner of the display 104; the unselected category appears in the upper right corner. In the center of the display 104 appears a stimulus randomly selected from either of the two groups of stimuli associated with or related to each of these two concepts. The respondent sorts each stimulus into the appropriate category by activating the associated input of the electronic input mechanism 110. This process is repeated for several trials (typically sixteen), and the time it takes the respondent to sort each stimulus is recorded by the system.

The third task, “combined task practice”, combines the first two tasks. In the upper left corner, “Biased” and a random alteration between “Self” and “Other” are displayed as category headings. In the upper right corner, “Unbiased” and whichever of “Self” and “Other” is not displayed in the upper left corner are displayed as category headings. In the center of the display appears a stimulus randomly selected from one of the four groups of stimuli associated with each of these four concepts used as category headings. The respondent sorts each stimulus into the appropriate category by activating the associated input of the electronic input mechanism 110. This process is repeated for several trials (typically thirty-two), and the time it takes the respondent to sort each stimulus is recorded by the system.

The fourth task, “combined task test”, follows the same procedure as the third task, except the number of trials is increased, typically to 128.

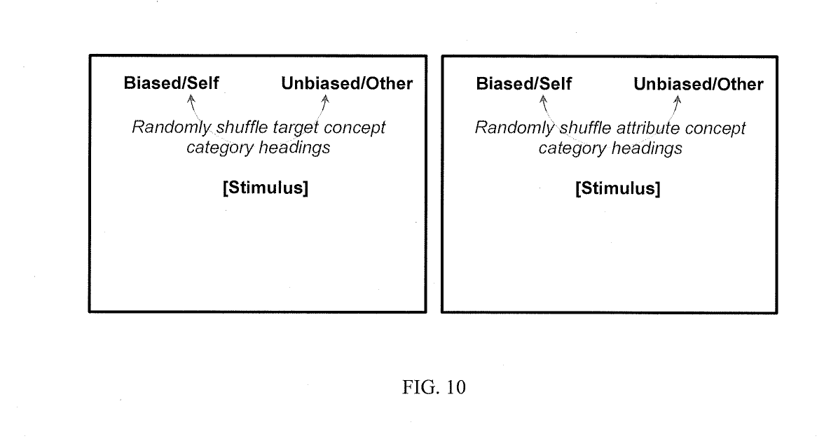

The Recoding-Free IAT can also be implemented by reversing the target and attribute concept category headings and the corresponding presentment of stimuli. The diagrams in FIG. 10 below illustrate the screen layouts of these two implementations of the Bias-Blindness Recoding-Free IAT.

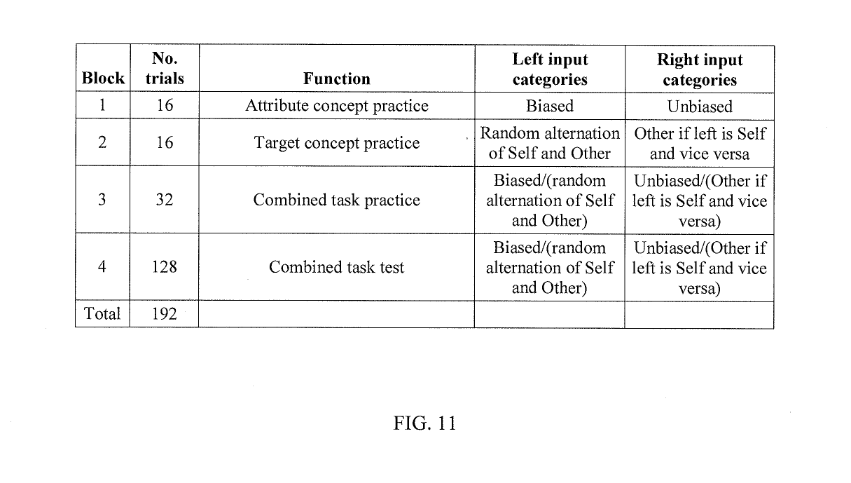

FIG. 11 summarizes the block and trial structure, and the target and attribute category headings for each block, of the Bias-Blindness Recoding-Free IAT.

A seventh implementation, also for minimizing recoding, is the “Single-Block IAT” (SB-IAT). The SB-IAT divides the display 104 into upper and lower halves, with the placement of the target or attribute category headings alternating between the left and right sides in each half. Stimuli are randomly presented in either the upper or lower half, with the placement indicating the category headings against which they are to be sorted by the user. The Bias-Blindness Single-Block IAT consists of eight tasks:

The first task is “target concept practice in the upper screen”. “Self” and “Other” appear as category headings in the upper left and upper right of the display, respectively. In the center of the display 104 appears a stimulus randomly selected from either of the two groups of stimuli associated with or related to each of these two concepts. The respondent sorts each stimulus into the appropriate category by activating the associated input of the electronic input mechanism 110: for example, the left-hand key if the stimulus is associated with the “Self” category, the right-hand key if it is associated with the “Other” category. This process is repeated for several trials (typically twenty-six), and the time it takes the respondent to sort each stimulus is recorded by the system.

The second task, “target concept practice in the lower screen”, repeats the first task, but with the position of the two target concept category headings reversed and placed near the bottom of the display 104: “Self” is now in the lower right and “Other” in the lower left. Stimuli are presented just below the center of the screen.

The third task is “combined target practice in the upper and lower screens”. “Self” appears in both the upper left and lower right of the display, and “Other” appears in the upper right and lower left. Stimuli associated with or related to these two categories are presented randomly either just above or just below a short horizontal line in the center of the display 104. If the stimulus appears above the line, the respondent sorts it according to the category headings at the top of the screen; below the line, according to the category headings at the bottom of the screen. This process is repeated for several trials (typically twenty-six), and the time it takes the respondent to sort each stimulus is recorded by the system.

The fourth task is “attribute concept practice in the upper and lower screens”. “Biased” appears on the left side of the display 104, vertically in the middle; “Unbiased” appears on the right side, opposite. Stimuli associated with or related to these two categories are presented randomly either just above or below a short horizontal line in the center of the screen. The respondent sorts each stimulus according to the category headings on each side of the screen. This process is repeated for several trials (typically twenty-six), and the time it takes the respondent to sort each stimulus is recorded by the system.

The fifth task, the “first combined test”, combines the third and fourth tasks. “Self” appears in both the upper left and lower right of the display 104, “Other” in the upper right and lower left; “Biased” appears on the screen's left side, vertically in the middle, “Unbiased” on the right side, opposite. Stimuli associated with or related to these four categories are presented randomly either just above or just below a short horizontal line in the center of the screen. If a stimulus appears above the line, the respondent must sort it according to the category headings at the top and sides of the screen; below the line, according to the category headings at the bottom and sides of the screen. This process is repeated for several trials (typically fifty-two), and the time it takes the respondent to sort each stimulus is recorded by the system.

The sixth through eighth tasks repeat the fifth.

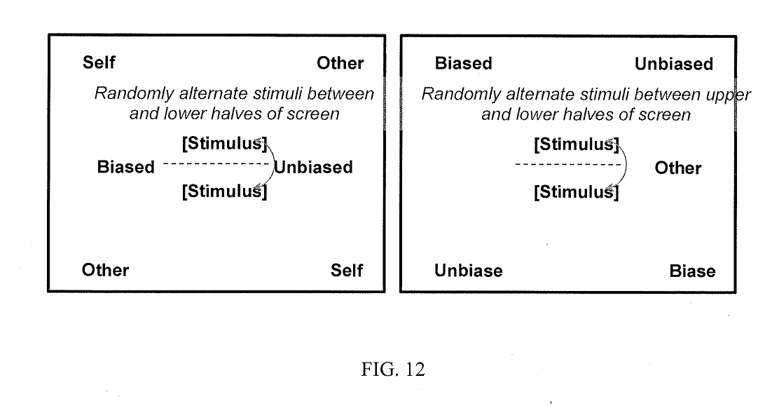

The Single-Block IAT can also be implemented by reversing the placement of the target and attribute concept category headings and the corresponding presentment of stimuli. FIG. 12 illustrates the screen layouts of these two versions of the Bias-Blindness Single-Block IAT.

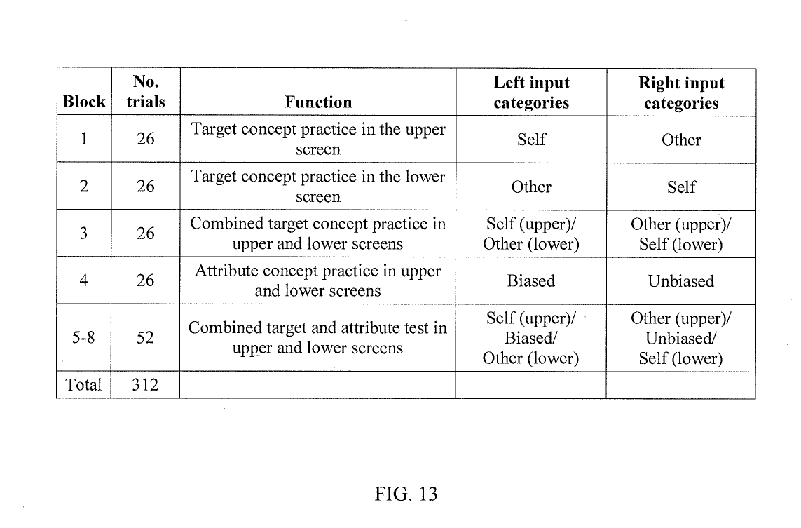

FIG. 13 summarizes the block and trial structure, and the target and attribute category headings for each block, of the Bias-Blindness Single-Block IAT.

The IAT effect for the Bias-Blindness Single-Block IAT can be computed using either scoring algorithm described above, although the D score is preferred. Under both algorithms, the data recorded in blocks 5-8 are separated into “compatible” (“Biased/Other” and “Unbiased/Self”) and “incompatible” (“Biased/Self” and “Unbiased/Other”) responses. Under the conventional algorithm, the compatible and incompatible response data in blocks 6, 7 and 8 are combined and substituted for the data in blocks 4 (compatible) and 7 (incompatible), respectively. Under the D score algorithm, the compatible and incompatible response data in blocks 5 and 6 are combined and substituted for the data in blocks 3 and 6, respectively; the compatible and incompatible response data in blocks 7 and 8 are combined and substituted for the data in blocks 4 and 7, respectively. The table in FIG. 14 (at the end of this document) summarizes the block response data used in calculating the IAT effect under each scoring algorithm for the Recoding-Free IAT.

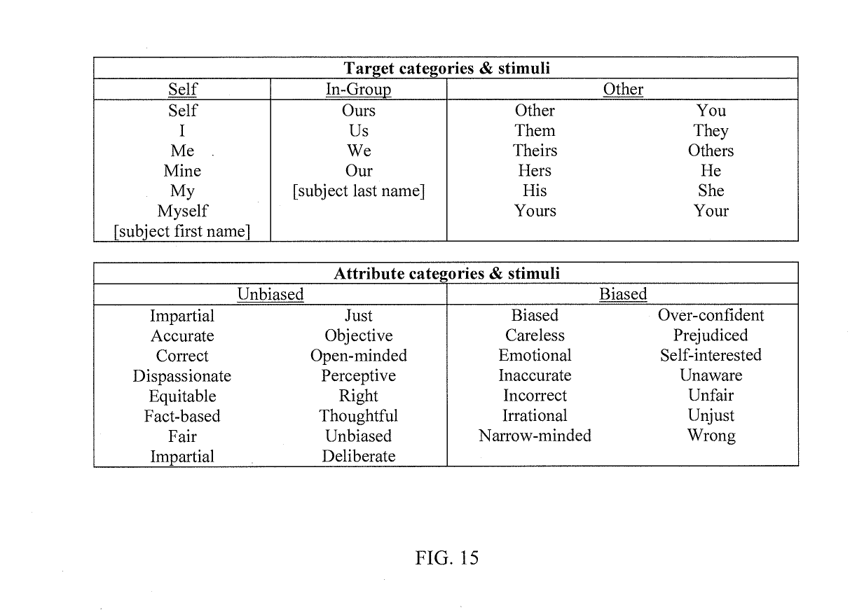

As described above, two primary classes of motives can cause cognitive bias: self-concept and in-group affiliation. For illustrative purposes, the various implementations of the Bias-Blindness IAT described above use a target category, “Self”, that reflects only the first motive. All implementations can be modified to capture the effect of the second motive by replacing either the “Self” or “Other” category with an “In-Group” target category of stimuli. “Self/Other” and “In-Group/Other” versions of the BB-IAT can measure the influence on cognitive bias of each of these self-concept and in-group affiliation motives on cognitive bias in isolation, while a “Self/In-Group” BB-IAT can determine their relative influence. Alternatively, the “In-Group” stimuli can be added to the “Self” category to determine the combined influence of both motives on cognitive bias. FIG. 15 (at the end of this document) provides illustrative lists of stimuli for each of the three relatedness and two biasedness categories that can be used with the BB-IAT.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
generating, by one or more processors of a machine, a series of sorting tasks for a user of a computer associated with the machine, the computer including an output device and an input device, each of the series of sorting tasks comprising a plurality of digital representations of stimuli associated with either relatedness to the user or biasedness;
providing, by the one or more processors, at least two digital representations of association categories as separate outputs from the output device, at least one of the at least two digital representations of the association categories being associated with the user's relatedness, and at least one other of the at least two digital representations of the association categories being associated with the user's biasedness, each of the separate outputs being associated with an input actuator of the input device;
executing, by the one or more processors, a sequence of two or more trials, each trial comprising:
providing, by the one or more processors, a randomly-selected digital representation of a stimulus to the output device in proximity to the separate outputs that provide the at least two digital representations of the association categories, the stimulus being associated with either the user's relatedness or biasedness represented by the at least two digital representations of the association categories;
receiving, by the one or more processors, a selection by the user from the input actuator of the input device in response to the stimulus, the selection indicating a category with which the user associates the stimulus; and
recording, by the one or more computer processors, a time between providing the randomly-selected digital representation of the stimulus and receiving the selection by the user via the input device; and
calculating, by the one or more computer processors, a score reflecting the strength of the user's implicit association between one pair of relatedness and biasedness categories, relative to the strength of the user's implicit association between another, different pair of relatedness and biasedness categories, the score being based at least partially on the time between providing the at least two randomly-selected digital representations of stimuli and receiving the selection by the user via the input device for each of the trials in the sequence of two or more trials.

2. A computer-implemented method in accordance with claim 1, wherein the randomly-selected digital representation of the stimulus is provided to the output device equidistant to the separate outputs that provide the at least two digital representations of the association categories.

3. A computer-implemented method in accordance with claim 1, wherein the input actuator of the input device includes at least two keys of a keyboard.

4. A computer-implemented method in accordance with claim 1, wherein the input actuator of the input device includes an actuator of a peripheral input device.

5. A computer-implemented method in accordance with claim 1, wherein the sequence of the two or more trials includes at least twenty trials.

6. A computer-implemented method in accordance with claim 1, further comprising outputting, by the one or more computer processors, the score to the output device.

7. A computer-implemented method in accordance with claim 1, further comprising outputting, by the one or more computer processors, the score to a communications network coupled with the machine.

8. A non-transitory computer program product storing instructions that, when executed by at least one programmable processor, cause the at least one programmable processor to perform operations comprising:
generate a series of sorting tasks for a user of a computer associated with the machine, the computer including an output device and an input device, each of the series of sorting tasks comprising a plurality of digital representations of stimuli associated with either relatedness to the user or biasedness;
provide at least two digital representations of association categories as separate outputs from the output device, at least one of the at least two digital representations of the association categories being associated with the user's relatedness, and at least one other of the at least two digital representations of the association categories being associated with the user's biasedness, each of the separate outputs being associated with a separate input of the input device;
execute a sequence of two or more trials, each trial comprising:
providing a randomly-selected digital representation of a stimulus to the output device in proximity to the separate outputs that provide the at least two digital representations of the association categories, the stimulus being associated with either the user's relatedness or biasedness represented by the at least two digital representations of the association categories;
receiving a selection by the user from one of the separate inputs of the input device in response to the stimulus, the selection indicating a category with which the user associates the stimulus; and
recording a time between providing the randomly-selected digital representation of the stimulus and receiving the selection by the user via the input device; and
calculate a score reflecting the strength of the user's implicit association between one pair of relatedness and biasedness categories, relative to the strength of the user's implicit association between another, different pair of relatedness and biasedness categories, the score being based at least partially on the time between providing the at least two randomly-selected digital representations of stimuli and receiving the selection by the user via the input device for each of the trials in the sequence of two or more trials.

9. A system comprising:
at least one programmable processor; and
a machine-readable medium storing instructions that, when executed by the at least one processor, cause the at least one programmable processor to perform operations comprising:
generating a series of sorting tasks for a user of a computer associated with the machine, the computer including an output device and an input device, each of the series of sorting tasks comprising a plurality of digital representations of stimuli associated with either relatedness to the user or biasedness;
providing at least two digital representations of association categories as separate outputs from the output device, at least one of the at least two digital representations of the association categories being associated with the user's relatedness, and at least one other of the at least two digital representations of the association categories being associated with the user's biasedness, each of the separate outputs being associated with a separate input of the input device;
executing a sequence of two or more trials, each trial comprising:
providing a randomly-selected digital representation of a stimulus to the output device in proximity to the separate outputs that provide the at least two digital representations of the association categories, the stimulus being associated with either the user's relatedness or biasedness represented by the at least two digital representations of the association categories;
receiving a selection by the user from one of the separate inputs of the input device in response to the stimulus, the selection indicating a category with which the user associates the stimulus; and
recording a time between providing the randomly-selected digital representation of the stimulus and receiving the selection by the user via the input device; and
calculating by the one or more computer processors, a score reflecting the strength of the user's implicit association between one pair of relatedness and biasedness categories, relative to the strength of the user's implicit association between another, different pair of relatedness and biasedness categories, the score being based at least partially on the time between providing the at least two randomly-selected digital representations of stimuli and receiving the selection by the user via the input device for each of the trials in the sequence of two or more trials.
